(19) United States
(12) Patent Application Publication
(10) Pub. No.: US 2020/0126104 A1
(43) Pub. Date: Apr. 23, 2020

(54) QUANTIFYING VALUE OF USER ACTIONS TO A DIGITAL MAGAZINE SYSTEM

(71) Applicant: Flipboard, Inc., Palo Alto, CA (US)

(72) Inventor: Mark Earl Plutowski, Cupertino, CA (US)

(21) Appl. No.: 16/168,761

(22) Filed: Oct. 23, 2018

(51) Int. Cl. G06Q 30/02; G06F 17/30

(52) U.S. Cl. CPC G06Q 30/0218; G06F 17/30058; G06Q 30/0239

(57) ABSTRACT

A digital magazine system rewards a target user based on value of the target user's actions to the digital magazine system. The digital magazine system quantifies value of an action by the target user with a content item based on how much the action contributed to view of the content item by viewing users. For example, the digital magazine system determine value of a viewing user's view of a content item to which the target user's action contributed and also determines how much of the value is attributed to the target user's action. The digital magazine system aggregates value of actions performed by the target user in a particular period of time to obtain a user value of the target user. The digital magazine system rewards the target user based on the user value.

### BACKGROUND

This disclosure relates generally to user actions with content published by a digital magazine system and more specifically to quantifying value of actions performed by a user and rewarding the user based on the value.

A digital magazine system disseminates a wide variety of digital content including text, images, audio, links, videos, and interactive media (e.g., games, collaborative content) to users. Users are allowed to make interactions with content items to express their emotions towards the content items. Interactions of a user with a content item can be presented to other users, e.g., users who are connected to the user. Therefore, the content item is within view of more users.

It is in the interest of content providers to get more users to view their content. Therefore, it is important to encourage users to make interactions that can surface content to other users in the digital magazine system. Despite the many existing ways to encourage users to interact with online content, there is a need for improved methods to reward users for their actions that contributed to other users' view of online content.

### SUMMARY

In various embodiments of the invention, a digital magazine system quantifies value of an action performed by a target user based on a determination of how much the action contributed to view of content by one or more other users. The digital magazine system further rewards the target user based on the quantified value. In some embodiments, the digital magazine system determines a user value for the target user based on multiple actions performed by the target user and rewards the target user based on the user value.

In one example, the digital magazine system maintains actions performed by users with content items in the digital magazine system. Example types of actions include posting a content item from a third party system to the digital magazine system, adding a content item provided by the digital magazine system to a user's reading list, viewing a content item, engaging with a content item, disengaging with a content item, sharing a content item within the digital magazine system, following a user, following a page, owning a page, inviting a potential user to join the digital magazine system, or any combination thereof. The digital magazine system retrieves a target action performed by a target user with a content item and view of the content item by another user (“viewing user”). The target action contributed, either directly or indirectly, to the view of the content item. As an example of direct contribution, the target action had been presented to the viewing user before the viewing user viewed the content item. As an example of indirect contribution, the target action had been presented to a third user before the third user performed an action on the content item. And the third user's action had been presented to the viewing user before the viewing user viewed the content item.

The digital magazine system determines a value of the viewing user's view of the content item based on a benefit to the system. The value may include both a monetary portion and an organic portion. The monetary portion may be computed based on a compensation to be received by the digital magazine system. The organic portion indicates an increase in interaction with the content item. Additionally, the digital magazine system identifies contributing actions (including the target action) that directly or indirectly contributed to the view of the content item by the viewing user. Each contributing action can play a different role in surfacing the content item to the viewing user. The digital magazine system quantifies value of the target action based on an estimation of how much the target action contributed to the view of the content item.

In some embodiments, the digital magazine system classifies the contributing actions into one or more categories and determines a category weight for the category of the target action. The category weight indicates how much the contributing actions in the category contributed to the view of the content item. The category weight can be a percentage. The digital magazine system can use different ways to classify the contributing actions. In one embodiment, the digital magazine system classifies the contributing actions into a direct contribution category (including actions that directly contributed to the view of the content item) and an indirect contribution category (including actions that indirectly contributed to the view of the content item). In another embodiment, the digital magazine system may also classify the actions based on types of the actions. For example, the digital magazine system classifies engaging, disengaging, and adding into a non-deterministic contribution category, classifies owning into a deterministic contribution category, and classifies sharing and following into a probabilistic contribution category. As another example, the digital magazine system classifies contributing actions of the same type into a same category, e.g., an engaging category, a following category, etc. In yet another embodiments, the digital magazine may classify the contributing actions as desirable/undesirable actions or internal/external actions.

Further, the digital magazine system distributes the category weight between the actions in the category to obtain a contribution weight of the target action. The digital magazine system can assign a same contribution weight to all contributing actions in the category. Then the digital magazine system determines a contribution value of the target action based on the value of the view of the content item and the contribution weight of the target action.

In some embodiments, the digital magazine system considers view of the content item by more than one viewing user and obtains a contribution value for the view of each viewing user. The digital magazine system aggregates the contribution values to obtain an action value of the target action. Also, the digital magazine system can consider multiple target actions performed by the target user and determine an action value for each target action. The digital magazine system aggregates the actions values to obtain a user value of the target user.

Based on either an action value or the user value, the digital magazine system rewards the target user. For example, the digital magazine system assigns a privileged status to the target user or allow the target user to perform administrative actions in the digital magazine system.

### BRIEF DESCRIPTION OF THE DRAWINGS

FIG. 1 is a high-level block diagram illustrating a system environment in which a digital magazine system operates, according to one embodiment.

FIG. 2 is a high-level block diagram illustrating a detailed view of the digital magazine system in which a rewarding module operates, according to one embodiment.

FIG. 3 is a high-level block diagram illustrating a detailed view of the rewarding module, according to one embodiment.

FIG. 4 illustrates an example of the rewarding module identifying view of content to which a target action of a target user contributed, according to one embodiment.

FIG. 5 is a flowchart illustrating a process of determining a contribution value of a target action performed by a target user with a content item, according to one embodiment.

FIG. 6 is a flowchart illustrating a process of quantifying value of a target user's action to reward the target user, according to one embodiment.

### DETAILED DESCRIPTION

### Digital Magazine System Environment

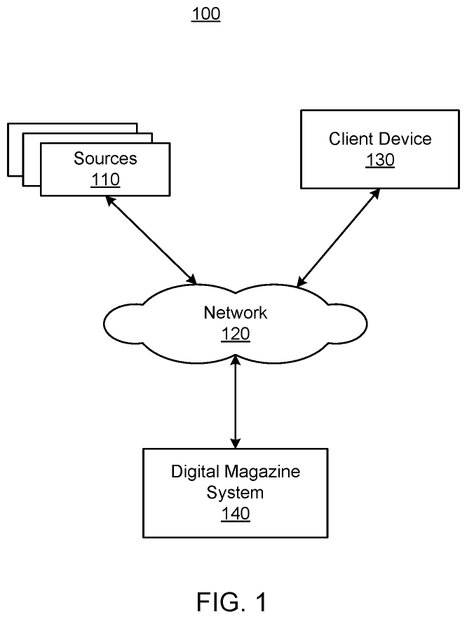

FIG. 1 is a high-level block diagram illustrating a system environment 100 in which a digital magazine system 140 operates, according to one embodiment. The system environment 100 shown in FIG. 1 includes one or more sources 110, a network 120, a client device 130, and a digital magazine system 140. In alternative configurations, different or additional portions may be included in the system environment 100. The embodiments described herein can be adapted to online systems that are not digital magazine systems 140 in various embodiments.

A source 110 is a computing system capable of providing various types of content to the client device 130 and the digital magazine system 140. In one embodiment, a content item provided by a source 110 is based on content of a resource coupled to a network 120 and identified by a network identifier, such as a Uniform Resource Locator (URL). For example, a source 110 is identified by a domain name included in a URL, which also includes information identifying content maintained by the source 110 corresponding to the domain name of the URL. Examples of content provided by a source 110 include text, images, video, or audio on web pages, web feeds, social networking information, messages, and other suitable data. Content provided by a source 110 may be received from a publisher (e.g., stories about news events, product information, entertainment, or educational material) and distributed by the source 110, or a source 110 may be a publisher of content it generates. For convenience, content from a source, regardless of its composition, may be referred to herein as one or more “content items,” or as “content.” A content item may include various types of objects, such as text, images, and video.

The sources 110 communicate with the client device 130 and the digital magazine system 140 via the network 120. The network 120 may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave view (WiMAX), 3G, 4G, code division multiple view (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

The client device 130 is a computing device capable of receiving user input as well as transmitting and/or receiving data via the network 120. Various embodiments of the client device 130 include a conventional computer system, such as a desktop or a laptop computer, and a device having computer functionality, such as a personal digital assistant (PDA), a mobile telephone, a smartphone, a smartwatch, or another suitable device. Different client devices 130 may have different characteristics such as different processing capabilities, different connection speeds with the digital magazine system 140 over the network 120, and different device types (e.g., make, manufacture, and version).

In some embodiments, the client device 130 executes a digital magazine application allowing a user of the client device 130 to interact with the digital magazine system 140. For example, the digital magazine application executing on the client device 130 communicates user input, which includes a request for a digital magazine, to the digital magazine system 140 and receives a digital magazine generated by the digital magazine system 140 based on the user input. The client device 130 also executes a browser that receives pages from the digital magazine system 140 and presents the pages to a user of the client device 130. In another embodiment, the client device 130 interacts with the digital magazine system 140 through an application programming interface (API) running on a native operating system of the client device 130, such as IOS® or ANDROID™. While FIG. 1 shows a single client device 130 for simplicity, in various embodiments, any number of client devices 130 may communicate with the digital magazine system 140.

In various embodiments, the client device 130 includes a display device, an input device, and a storage device. The display device presents content, such as that comprising a digital magazine received from the digital magazine system 140, to a user of the client device 130. Examples of a display device include a liquid crystal display (LCD), an organic light emitting diode (OLED) display, and an active matrix liquid crystal display (AMLCD). Different client devices may have display devices with different characteristics. For example, different client devices have display devices with different display areas, different resolutions, or differences in other characteristics.

The input device receives input from a user of the client device 130. For example, the input device receives a request from a user for a digital magazine or other content. Different input devices may be included in the client device 130. For example, the client device 130 may include a touch-sensitive display for receiving input data, commands, or information from a user. Using a touch-sensitive display allows the client device 130 to combine the display device and the input device, simplifying user interaction with presented content items. In other embodiments, the client device 130 may include a keyboard, a trackpad, a mouse, or any other device capable of receiving input from a user. Additionally, the client device 130 may include multiple input devices in some embodiments. Inputs received via the input device may be processed by a digital magazine application associated with the digital magazine system 140 and executing on the client device 130 to allow a user to interact with content items presented by the digital magazine system 140.

The storage device of the client device 130 includes content for presentation to the user. Additionally, the storage device maintains instructions that, when executed by a processor of the client device 130, cause the client device 130 to provide various functionalities to the user. For example, the storage device maintains instructions that, when executed by the processor of the client device 130, cause the client device 130 to execute one or more applications. In some embodiments, instructions maintained by the storage device cause a digital magazine application associated with the digital magazine system 140 and executing on the client device 130 to retrieve content items included in the storage device and present the content items to the user.

The digital magazine system 140 receives content items from one or more sources 110, generates a digital magazine by processing the received content, and provides the digital magazine to the client device 130. A digital magazine is a personalized, customizable collection of digital content items selected for a user of a digital magazine system for presentation to a user of a client device (e.g., a mobile communication device, tablet, computer, and any other suitable computing system). For example, the digital magazine system 140 maintains information describing a user's interests or preferences and selects content items from various sources for presentation to a user based on the user's interests and preferences. The digital magazine system 140 sends the selected content items to a client device associated with the user along with instructions for presenting the selected content items in a digital magazine to the user. A digital magazine application executing on the client device generates the digital magazine presenting the selected content items to the user based on the received instructions. The generated digital magazine allows the user to more easily view digital content by presenting content items in an easily navigable interface via the client device.

In various embodiments, the layout specified by the digital magazine system resembles formats used by print magazines. The digital magazine system 140 generates one or more pages for presentation to a user based on content items obtained from one or more sources 110 and information describing organization and presentation of content items. For example, the digital magazine system 140 determines a page layout specifying positioning of content items relative to each other based on information associated with a user and generates a page including the content items arranged according to the determined layout for presentation to the user via the client device 130. This allows the user to view content items via the client device 130 in a format that enhances the user's interaction with and consumption of the content items. For example, the digital magazine system 140 provides a user with content items in a format similar to the format used by print magazines. By presenting content items in a format similar to a print magazine, the digital magazine system 140 allows a user to interact with content items from multiple sources 110 via the client device 130 with less inconvenience from horizontally or vertically scrolling to view various content items.

In one embodiment, a digital magazine assembles a list of universal resource locators (URLs), where each content item of the digital magazine is based on content from a source identified by a corresponding URL of the list of the URLs. A “content item” herein refers to any machine-readable and machine-storable work product, such as textual articles, pictures, images, videos, user-generated content (e.g., content posted on a social networking system or content items stored in the local memory of a computing device used by the user), advertisements, and any other types of digital content capable of display within the context of a digital magazine.

In various embodiments, the digital magazine system 140 receives a request for a digital magazine from the client device 130 that identifies a user of the digital magazine system 140 and one or more topics. For each topic included in the request, the digital magazine system 140 generates a digital magazine including digital content relevant to the topic and sends the digital magazine to the client device 130. In other embodiments, the digital magazine system 140 receives an indication that the user is viewing (e.g., logging-in to) a digital magazine application associated with the digital magazine system 140 and executing on the client device 130. The indication includes information identifying the user to the digital magazine system 140, which retrieves a user profile or other information maintained by the digital magazine system 140 in association with the user. For example, the digital magazine system 140 retrieves one or more interests included in a user profile maintained by the digital magazine system 140 for the user and generates a digital magazine based on one or more interests retrieved from the user profile.

The digital magazine system 140 may regularly update, with or without requests from the client device 130, one or more digital magazines for a user and communicate the updated digital magazines to the client device 130.

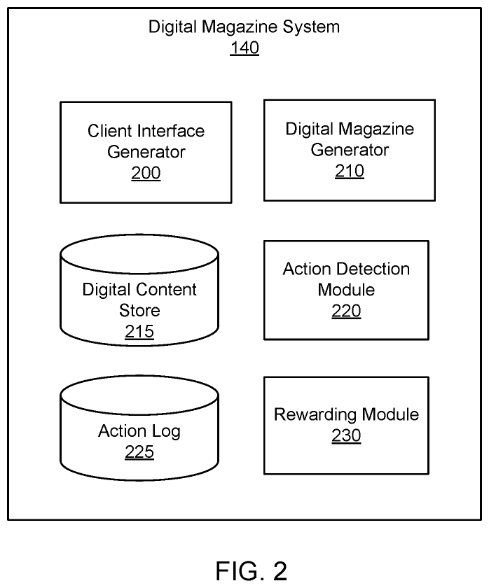

FIG. 2 is a high-level block diagram illustrating a detailed view of the digital magazine system 140 in which a rewarding module 230 operates, according to one embodiment. In the example shown by FIG. 2, the digital magazine system 140 includes a client interface generator 200, a digital magazine generator 210, a digital content store 215, an action detection module 220, an action log 225, and the rewarding module 230. In other embodiments, the digital magazine system 140 may include additional, fewer, or different portions for various applications. In some embodiments, the functions are distributed among by the modules in a different manner than described herein. Moreover, the functions are performed by other entities in some embodiments.

The client interface generator 200 receives requests for digital magazines from the client devices 130 and communicates to the client device 130 digital magazines generated by the digital magazine generator 210 in response to the received requests. In one embodiment, the information included in a received request includes one or more topics (e.g., a root topic) selected by the user. A root topic may have one or more subtopics, each of which is more specific than the root topic and provides information to more accurately identify more specific interests of the user. For example, a root topic of “Technology” has a subtopic of “self-driving vehicles.”

The digital magazine generator 210 generates a digital magazine based on a request received from a client device 130. In one embodiment, the digital magazine generator 210 extracts a topic from the received request. The extracted topic can be one or more key words in the received request. The digital magazine generator 210 may also associate the extract topic with a root topic. Further, the digital magazine generator 210 selects content items based on the root topic and the extracted topic. The digital magazine generator 210 may apply a logical AND operation with both the extracted topic and the root topic prior to selecting one or more content items. For example, given a root topic of “Technology” and an extracted topic of “Design,” the digital magazine generator 210 selects content items having topics of both “Technology” and “Design”. The digital magazine generator 210 can also rank the selected content items based on their relevance to the root topic and the extracted topic and determine positions of the selected content items in the digital magazine based on the ranking. The generated digital magazine is sent to the client interface generator 200, which transmits the digital magazine to a client device 130 from which the request was received.

The digital magazine generator 210 can update the generated digital magazine. The client interface generator 200 detects an update to the digital magazine and communicates the updated digital magazine, or information identifying one or more changes to the digital magazine, to the client device 130.

The digital content store 215 stores various types of content items obtained by the digital magazine system 140 from one or more sources 110 or from any other suitable entity. In one embodiment, the digital content store 215 stores uniform resource locators (URLs) that each identify a content item. In another embodiment, a content item comprises multiple URLs. For example, the digital content store 215 stores content items received from one or more sources 110 within a threshold amount of time from a current time (e.g., 6 months). Examples of content items stored by the digital content store 215 include page posts, status updates, photographs, videos, links, news articles, audio files, or any other types of content. The machine-selected content module 230 and the editorial module 240 retrieve content items form the digital content store 215, as further described below.

The action detection module 220 detects actions performed by users in the digital magazine system 140 or in a third party system that is external to the digital magazine system 140. For example, users may post content items (either from third party systems or created by users) into digital magazines provided by the digital magazine system 140 or interact with various content items displayed on pages of digital magazines on client devices 130. As another example, users may interact with other users of the digital magazine system 140 or even interact with a potential user of the digital magazine system 140. The action detection module 220 obtains information describing these actions and stores the information describing the actions in the action log 225. Example types of user actions include: posting a content item from a third party system to the digital magazine system 140, viewing a content item, engaging with a content item, disengaging with a content item, adding a content item to a user's reading list, sharing a content item within the digital magazine system, following a user, inviting a person to become a user of the digital magazine system 140, following a page, owning a page, and so on.

The action log 225 stores actions performed by users with content items included in digital magazines. For example, the action log 225 stores a description of an action performed by a user with a content item, an identifier of the content item, an identifier of the user who performed the action, and a time stamp indicating when the action was performed. In some embodiments, the identifier of the content item includes a domain name of a source 110 from which the content item was obtained. In some embodiments, data from the action log 225 includes information included in received requests for digital magazines, which may be obtained from the client interface generator 200. Data from the action log 225 is used to infer interests or preferences of users of the digital magazine system 140 in various embodiments, allowing a more complete understanding of user interests or preferences. For example, content items with which a user previously interacted are retrieved by the digital magazine system 140 using the content item identifiers, allowing the digital magazine system 140 to recommend content items to the user based on the content items with which the user previously interacted.

The rewarding module 230 quantifies value of one or more actions performed by a target user and rewards the target user based on the value. For example, the rewarding module 230 retrieves actions performed by the target user from the action log 225. Further, the rewarding module 230 determines an action value for each action and aggregates the action values as a user value for the target user.

To determine an action value, the rewarding module 230 identifies view of the content item that is directly and/or indirectly triggered by the corresponding action. The view of the content item is performed by users other than the target user, i.e., viewing users. The target user's action directly contributes to the viewing user's view of the content item if the target user's action had been presented to a viewing user before the view. In contrast, the target user's action indirectly contributes to the viewing user's view of the content item if the target user's action had been presented to a third user before the third user performed an action with the content item and the third user's action contributed to the view.

The rewarding module 230 determines a contribution value of the target action for view of the content item by each viewing user based on an estimation of how much the target action contributed to the viewing user's view of the content item. The contribution value indicates a portion of a value of the view attributed to the target action. The rewarding module 230 determines the value of the view of the content item and also identifies a group of contributing actions for the view. The contributing actions includes the target user's action and other actions with the content item that also plays a role in surfacing the content item to the viewing user.

The rewarding module 230 classifies the contributing actions into one or more categories, e.g., based on types of the contributing actions. The rewarding module 230 assigns a category weight to each category and evenly distribute the category weight to the actions in the category as contribution weight of the contribution actions. In some embodiments, a contribution weight is a percentage. Based on the contribution weight of the target action and the value of the view, the rewarding module 230 obtains the contribution value of the target action. A category weight or contribution weight can be negative, indicating the corresponding action plays a role in preventing the viewing user from viewing the content item. Accordingly, the contribution value of the target action can be negative too.

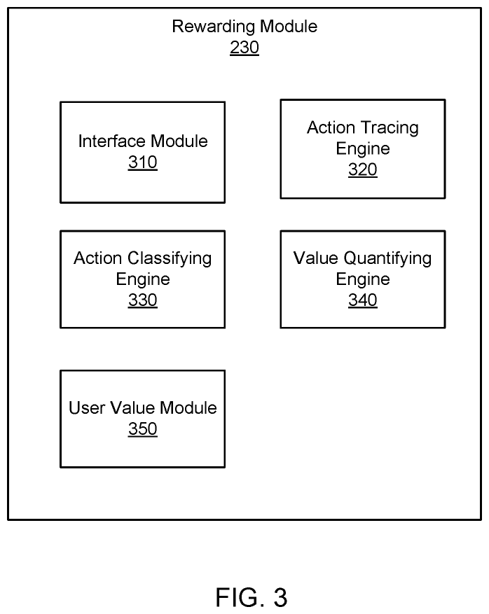

Further, the rewarding module 230 aggregates the contribution values of the target action for the view by all the viewing users to obtain an action value of the target action. Additionally, the rewarding module 230 may aggregate action value of multiple actions performed by the target user to obtain a user value of the target user. The rewarding module 230 rewards the target user based on either an action value or the user value. For example, the rewarding module 230 assigns a privileged status in the online system to the target user. The rewarding module 230 can select the privileged status based on the action value. Alternatively or additionally, the rewarding module 230 may allow the target user to perform administrative actions in the digital magazine system responsive to the action value beyond a threshold value. More details about the rewarding module 230 are provided in conjunction with FIG. 3.

### Quantifying Value of User Action

FIG. 3 is a high-level block diagram illustrating a detailed view of the rewarding module 230, according to one embodiment. As discussed above, the rewarding module 230 quantifies value of actions performed by a user and rewards the user based on the quantified value. The rewarding module 230 in the embodiment of FIG. 3 includes an interface module 310, an action tracing engine 320, an action classifying engine 330, a value quantifying engine 340, and a user value module 350. In other embodiments, the rewarding module 230 may include additional, fewer, or different portions for various applications.

The interface module 310 facilitates communication of the rewarding module 230 with other entities. For example, the interface module 310 retrieves actions performed by users with content items from the action log 220. As another example, the interface module 310 sends information about rewarding the target user to a client device 130 associated with the target user.

The action tracing engine 320 retrieves one or more target actions performed by a target user with one or more content items during a particular period of time. The period of time can be a specified duration of time, e.g., one hour, one day, one week, etc. Or the rewarding module 230 determines (or receives, for example, from a special user) a starting time and an ending time. The particular period of time is between the starting time and ending time. The action tracing engine 320 can periodically retrieve target actions for periodically quantify value of the target user's actions. For example, the action tracing engine 320 retrieves target actions every week or every month.

The action tracing engine 320 also identifies view of a content item to which each target action contributed. The view of the content item can be by a plurality of viewing users to whom the target action (or actions triggered by the target action) had been presented. An action is triggered by the target action is the action was performed by a user after the target action had been presented to the user. In some embodiments, the viewing users are connected to the target user or to users who are connected to the target user. As the digital magazine system 140 presents actions performed by users with content item to connections of the users, the target action (or actions triggered by the target action) surfaced the content item to the viewing users. Therefore, the target action contributed to the viewing users' view of the content item.

Further, the action tracing engine 320 identifies a group of contributing actions for the view of the content item by each of the viewing users. The contributing actions include the target action. A contributing action plays a role in surfacing the content item to the viewing user.

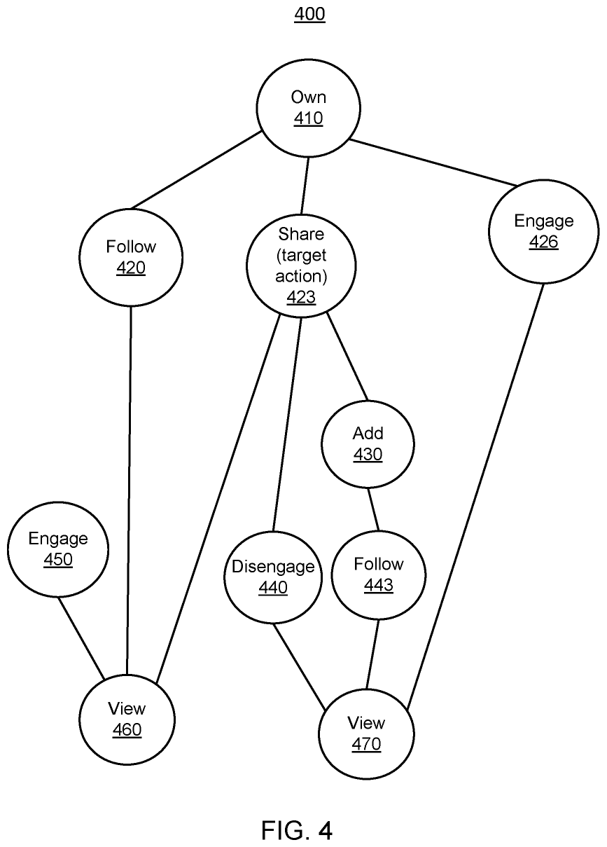

FIG. 4 illustrates an example of identifying view of a content item to which a target action of a target user contributed and identifying a group of contributing actions for the view of the content item by each of the viewing users, according to one embodiment. Each circle in FIG. 4 represents an action performed by a user with the content item. The reference number of each circle represents a user and the word in each circle shows a type of the action performed by the user. FIG. 4 includes view of the content item by three viewing users 460 and 470. The other actions in FIG. 4 contributed, directly or indirectly to the view of the content item by the viewing users 460 and 470.

User 423 is the target user and sharing is the target action. The action tracing engine 320 identifies view of the content item by users 460 and 470, to which the sharing of user 423 contributed. As shown in FIG. 4, the content item owned by user 410 is presented in digital magazines provided to users 420, 423, and 426, who performed different actions with the content item. User 420 followed the content item, user 423 shared the content item, and user 426 engaged with the content item.

The action tracing engine 320 determines that the sharing by user 423 had been presented to user 460, which surfaced the content item to user 460, before user 460 viewed the content item. Thus, the sharing by user 423 (i.e., the target action) contributed to the view by user 460. Besides the sharing by user 423, the actions of users 420 and 450 had also been presented to user 460 before user 460 viewed the content item. Thus, the actions of users 423, 420, and 450 all directly contributed to the view by user 460. The action by user 410, owning the content item, indirectly contributed to the view by user 460. The action tracing engine 320 identifies four contributing actions for the view by user 460: the owning by user 410, the following by user 420, the sharing by user 423 (i.e., the target action), and the engaging by user 450. Similarly, the action tracing engine 320 can identify six contributing actions for the view by user 470: the owning by user 410, the sharing by user 423 (i.e., the target action), the engaging by user 426, the disengaging by user 440, the adding by user 430 (e.g., adding the content item to a reading list of the user), and the following by user 443.

Referring back to FIG. 3, the action classifying engine 330 classifies the contributing actions identified by the action tracing module 330. In some embodiments, the action classifying engine 330 classifies a contributing action based on whether the contributing action contributes to the viewing user's view of the content item directly or indirectly. A contributing action directly contributes to the viewing user's view of the content item when the contributing action had been presented to the viewing user before the viewing user's view of the content item. A contributing action indirectly contributes to the viewing user's view of the content item when the contributing action triggered an action by another user and the other user's action had been presented to the viewing user before the viewing user's view of the content item. Taking the six contributing actions of the view by user 470 in FIG. 4 for example, the action classifying engine 330 classifies the owning by user 410, the sharing by user 423 (i.e., the target action), the engaging by user 426, and the adding by user 430 into the direct contribution category, and classifies the disengaging by user 440 and the following by user 443 into the indirect contribution category.

In some other embodiments, the action classifying engine 330 classifies a contributing action based on a type of the contributing action. For example, the rewarding module 230 classifies the contributing actions into a deterministic contribution category, a probabilistic contribution category, and a non-deterministic contribution category. In the example of the six contributing actions of the view by user 470 in FIG. 4, the action classifying engine 330 classifies the owning by user 410 into the deterministic contribution category, classifies the sharing by user 423 (i.e., the target action) and the following by user 443 into the probabilistic contribution category, and classifies the engaging by user 426, the adding by user 430, and the disengaging by user 440 into the non-deterministic contribution category. In some other embodiments, the action classifying engine 330 classifies a contributing action as either a desirable action or an undesirable action. For example, an action that meets terms of service of the digital magazine system 140 is a desirable action. Otherwise, it is an undesirable action. Examples of undesirable actions include posting illegal content and making comments that include any illegal content. In yet some other embodiments, the action classifying engine 330 classifies a contributing action as either an internal action or an external action. Internal actions are actions performed within the digital magazine system 140, such as interactions with users of the digital magazine system 140 and interactions with content item provided by the digital magazine system 140. External actions are actions that are performed in third party systems but related to the digital magazine system 140, such as posting a content item from a third party system to the digital magazine system and inviting a person to join the digital magazine system.

The value quantifying engine 340 determines a value for the viewing user's view of the content item. To determine the value, the rewarding module 230 determines a monetary portion of the value based on a compensation from a provider of the content item for the view. Also, the rewarding module 230 determines an organic portion of the value based on an increase in user interaction in the digital magazine system 140. The rewarding module combine the monetary portion and the organic portion to obtain the value for the view.

Further, the value quantifying engine 340 distributes the value to the contributing actions to determine a contribution value of the target action. The value quantifying engine 340 determines a category weight for each category. The category weight indicates the importance of the contributing actions in the category to surfacing the content item to the viewing user. For example, the rewarding module 230 determines that the direct contribution category has a category weight of 70% versus 30% for the indirect contribution category. As another example, the deterministic contribution category has a category weight of 50%, versus 30% for the probabilistic contribution category, and 20% for the non-deterministic contribution category.

The value quantifying engine 340 then determines a contribution weight to each contributing action in the category. In some embodiments, the value quantifying engine 340 evenly distributes the category weight to each contributing action so that the contribution weight of each contributing action equals the category weight divided by the number of contributing actions in the category. In an example where the non-deterministic contribution category has a category weight of 20% and includes one action of engaging and one action of adding, each of the two contributing actions has a contribution weight of 10%. In some other embodiments, the value quantifying engine 340 determines a contribution weight for a contributing action based on the type of the contributing action. For example, engaging can have a higher contribution weight than adding.

A contribution weight of a contributing action can be a negative value, indicating that the contributing action negatively contributes to the viewing user's view of the content item, such as the contributing action discourages the viewing user from viewing the content item. For example, a contributing action of disengaging can have a negative contribution weight.

Then the value quantifying engine 340 determines a contribution value for the target action based on the value of the viewing user's view of the content item and the contribution weight of the target action. For instance, the value quantifying engine 340 multiples the value of the viewing user's view of the content item with the contribution weight of the target action. As the contribution weight of the target action may be negative, the contribution value for the target action may be a negative value.

The user value module 350 determines an action value for the target action by aggregating the contribution value of the target action for each viewing user's view of the content item. In embodiments where there are more than one target action, the user value module 350 determines action values for other target actions performed by the target user. The user value module 350 obtains a user value for the target user by aggregating the action values of all the target actions.

Moreover, the user value module 350 rewards the target user based on the user value. For example, in response to an action value or the user value beyond a threshold value, the user value module 350 assigns a privileged status to the target user. With the privileged status, the target user can get access to premium content, a discount to subscription of a digital magazine, and/or access to an advertisement-free version of a digital magazine. The target user can also be recognized as a trustworthy user by other users. For example, the target user is rewarded with reputation credits, which can be displayed in the target user's profile. Also, the target user may be allowed to customize its user interface. Additionally or alternatively, the target user can perform administrative actions with content, e.g., editing content, hiding content, reporting content to the digital magazine system 140, voting on a new feature of the digital magazine system 140, voting for/against content topics, and so on. The target user can be entered into a contest for competition with other users based on their user values.

In embodiments where the target user has a negative action value or a negative user value, the user value module 350 can give the target user a penalty. For example, the user value module 350 can remove a privileged status that the target user already has or move the target user to a limited status that the target user would be allowed to perform limited types of actions. The digital magazine system can periodically re-quantify the user value of the target user and update the target user's status in the digital magazine system accordingly.

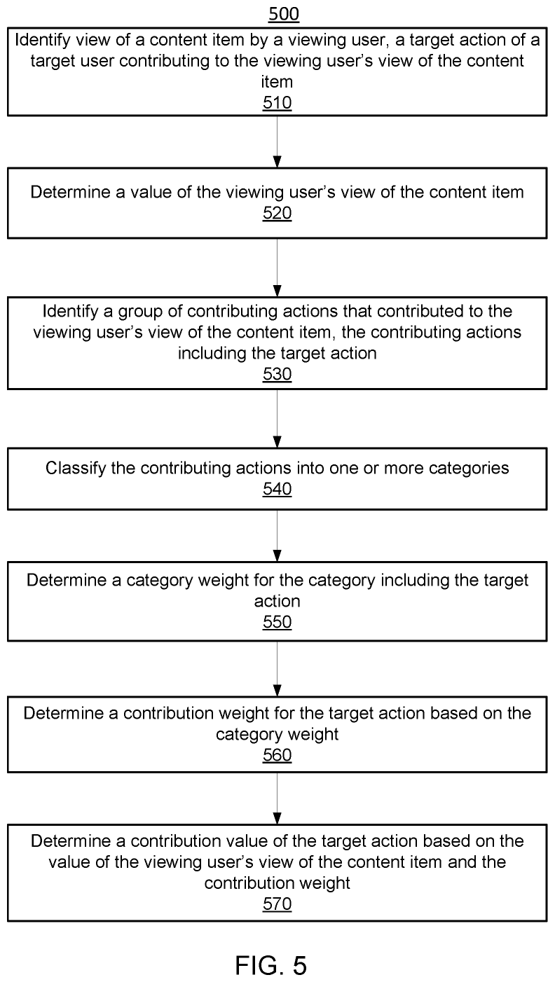

FIG. 5 is a flowchart illustrating a process 500 of determining a contribution value of a target action performed by a target user with a content item, according to one embodiment. In some embodiments, the process 500 is performed by the rewarding module 230, although some or all of the steps of the method may be performed by other entities in other embodiments. In some embodiments, steps of the process 500 are performed in a different order than the order described in conjunction with FIG. 5 and may include different or additional steps.

The rewarding module 230 identifies 510 view of a content item by a viewing user. The target action contributed to the viewing user's view of the content item. The target action played a role to surface the content item to the viewing user and contributed to the viewing user's view of the content item.

The rewarding module 230 determines 520 a value of the viewing user's view of the content item. To determine the value, the rewarding module 230 determines a monetary portion of the value based on a compensation from a provider of the content item for the view. Also, the rewarding module 230 determines an organic portion of the value based on an increase in user interaction in the digital magazine system 140. The rewarding module 230 combines the monetary portion and the organic portion to obtain the value for the view.

The rewarding module 230 identifies 530 a group of contributing actions that contributed to the viewing user's view of the content item. The contributing actions includes the target action performed by the target user. Further, the rewarding module 230 classifies 540 the contributing actions into one or more categories. For example, the rewarding module 230 classifies the contributing actions into a direct contribution category and an indirect contribution category. Contributing actions that had been presented to the viewing user before the viewing user's view of the content item are classified into the direct contribution category. Contributing actions that had been presented to other users who performed actions contributed to the viewing user's view of the content item are classified into the indirect contribution category. As another example, the rewarding module 230 classifies the contributing actions into a deterministic contribution category, a probabilistic contribution category, and a non-deterministic contribution category based on types of the contribution action.

The rewarding module 230 determines 550 a category weight for the category including the target action. In one embodiment, a category weight indicates a percentage of the value of the view. The rewarding module 230 determines that a category has a higher category weight if the contributing actions in the category played more important roles in surfacing the content item to the viewing user. For example, the rewarding module 230 determines that the direct contribution category has a category weight of 70% versus 30% for the indirect contribution category. As another example, the deterministic contribution category has a category weight of 50%, versus 30% for the probabilistic contribution category, and 20% for the non-deterministic contribution category. The category weight of a category can be other types of values.

The rewarding module 230 determines 560 a contribution weight for the target action based on the category weight. For example, the rewarding module 230 evenly distribute the category weight into the contributing actions in the category. The rewarding 230 can divide the category weight with the number of contributing actions in the category to obtain the contribution weight for the targeting action. In an embodiment where the category weight is 70% and the category includes five contributing actions (including the target action), the contribution weight of the target action is 14%. As another example, the rewarding module 230 assigns the category weight to the contributing actions in the category based on types of the contributing action. In an embodiment where the category weight is 70% and the category include the target action (which is sharing) and another contributing action (which is engaging), the rewarding module 230 assigns a larger portion of the category weight (e.g., 40%) to the target action.

Further, the rewarding module 230 determines 570 a contribution value of the target action based on the value of the viewing user's view of the content item and the contribution weight. In one embodiment, the rewarding module 230 multiples the contribution weight of the target action with the value of the viewing user's view of the content item.

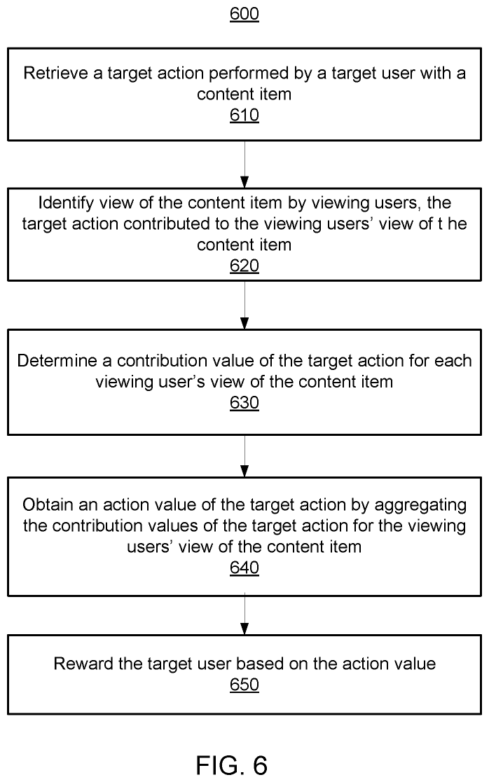

FIG. 6 is a flowchart illustrating a process 600 of quantifying value of a target user's action to reward the target user, according to one embodiment. In some embodiments, the process 600 is performed by the rewarding module 230, although some or all of the steps of the process 600 may be performed by other entities in other embodiments. In some embodiments, steps of the process 600 are performed in a different order than the order described in conjunction with FIG. 6 and may include different or additional steps.

The rewarding module 230 retrieves 610 the target action performed by the target user with a content item. For example, the rewarding module 230 retrieves the target action the action log 215 of the digital magazine system 140.

The rewarding module 230 identifies 620 view of the content item by viewing users. The target action contributed to the viewing users' view of the content item. The view of the content items can be by a plurality of viewing users to whom the target action had been presented or actions triggered by the target action had been presented. The target action (or actions triggered by the target action) surfaced the content item to the viewing users and therefore, contributed to the viewing users' view of the content item.

The rewarding module 230 determines 630 a contribution value of the target action for each viewing user's view of the content item. In some embodiments, the rewarding module 230 determines the contribution value by the process 500 described above in conjunction with FIG. 5. Further, the rewarding module 230 obtains 640 an action value of the target action by aggregating the contribution values of the target action for the view of content item by the viewing users.

The rewarding module 230 rewards 650 the target user based on the action value. In some embodiments, the rewarding module 230 assigns a privileged status in the online system to the target user. The rewarding module 230 can select the privileged status based on the action value. In some embodiments, the rewarding module 230 may allow the target user to perform administrative actions in the digital magazine system responsive to the action value beyond a threshold value.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it also has proven convenient at times to refer to these arrangements of operations as modules, without loss of generality. The described arrangements of operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

The above description is included to illustrate the operation of the preferred embodiments and is not meant to limit the scope of the invention. From the above discussion, many variations will be apparent to one skilled in the relevant art that would yet be encompassed by the spirit and scope of the invention.

What is claimed is:

1. A method comprising:
maintaining actions performed by users with content items in a digital magazine system;
retrieving a target action performed by a target user with a content item;
identifying view of the content item by viewing users of the digital magazine system, the target action contributing to the viewing users' view of the content item;
determining a contribution value of the target action for each viewing user's view of the content item, wherein determining the contribution value comprises:
determining a value of the viewing user's view of the content item,
identifying a group of contributing actions that contributed to the viewing user's view of the content item, the contributing actions including the target action,
classifying the contributing actions into one or more categories,
determining a category weight for a category including the target action,
determining a contribution weight for the target action based on the category weight, and
determining a contribution value of the target action based on the value of the viewing user's view of the content item and the contribution weight;
obtaining an action value of the target action by aggregating the contribution values of the target action for the viewing users' view of content item; and
rewarding the target user based on the action value.

2. The method of claim 1, further comprising:
retrieving other actions performed by the target user with content items in the digital magazine system during a particular period of time;
determining an action value for each of the other actions;
obtaining a user value for the target user by aggregating the action values of the other actions and the action value of the target action; and
rewarding the target user based on the user value.

3. The method of claim 1, wherein determining a contribution weight for the target action based on the category weight comprises:
evenly distributing the category weight among the contributing actions in the category.

4. The method of claim 1, wherein the one or more categories include at least one of the following: deterministic contribution, probabilistic contribution, and non-deterministic contribution.

5. The method of claim 1, wherein the one or more categories include at least one of the following: direct contribution and indirect contribution.

6. The method of claim 1, wherein the contributing actions are classified into the one or more categories based on types of the contributing actions.

7. The method of claim 6, wherein the types of the contributing actions include at least one of the following: posting, engaging, disengaging, adding, sharing, owning, following, or any combination thereof.

8. The method of claim 1, wherein the value of a viewing user's view of the content item comprises a monetary portion to be received by the digital magazine system and an organic portion indicating an increase in user interaction in the digital magazine system.

9. The method of claim 1, wherein rewarding the target user based on the action value comprises:
assigning a privileged status in the digital magazine system to the target user, the privileged status determined based on the action value.

10. The method of claim 1, wherein rewarding the target user based on the action value comprises:
responsive to the action value beyond a threshold value, allowing the target user to perform administrative actions in the digital magazine system.

11. A non-transitory computer readable medium storing executable computer program instructions, the computer program instructions comprising instructions that when executed cause a computer processor to:
maintain actions performed by users with content items in a digital magazine system;
retrieve a target action performed by a target user with a content item;
identify view of the content item by viewing users of the digital magazine system, the target action contributing to the viewing users' view of the content item;
determine a contribution value of the target action for each viewing user's view of the content item, wherein the computer program instructions for determining the contribution value comprise instructions that when executed cause the computer processor to:
determine a value of the viewing user's view of the content item,
identify a group of contributing actions that contributed to the viewing user's view of the content item, the contributing actions including the target action,
classify the contributing actions into one or more categories,
determine a category weight for a category including the target action,
determine a contribution weight for the target action based on the category weight, and
determine a contribution value of the target action based on the value of the viewing user's view of the content item and the contribution weight;
obtain an action value of the target action by aggregating the contribution values of the target action for the viewing users' view of content item; and
reward the target user based on the action value.

12. The computer readable medium of claim 11, the computer program instructions further comprising instructions that when executed cause a computer processor to:
retrieve other actions performed by the target user with content items in the digital magazine system during a particular period of time;
determine an action value for each of the other actions;
obtain a user value for the target user by aggregating the action values of the other actions and the action value of the target action; and
reward the target user based on the user value.

13. The computer readable medium of claim 11, wherein the computer program instructions for determining a contribution weight for the target action based on the category weight comprise instructions that when executed cause the computer processor to:
evenly distribute the category weight among the contributing actions in the category.

14. The computer readable medium of claim 11, wherein the one or more categories include at least one of the following: deterministic contribution, probabilistic contribution, and non-deterministic contribution.

15. The computer readable medium of claim 11, wherein the one or more categories include at least one of the following: direct contribution and indirect contribution.

16. The computer readable medium of claim 11, wherein the contributing actions are classified into the one or more categories based on types of the contributing actions.

17. The computer readable medium of claim 16, wherein the types of the contributing actions include at least one of the following: posting, engaging, disengaging, adding, sharing, owning, following, or any combination thereof.

18. The computer readable medium of claim 11, wherein the value of a viewing user's view of the content item comprises a monetary portion to be received by the digital magazine system and an organic portion indicating an increase in user interaction in the digital magazine system.

19. A computer system comprising:
a non-transitory computer-readable storage medium storing executable computer program instructions, the computer program instructions comprising instructions that when executed cause a computer processor to perform steps, comprising:
maintaining actions performed by users with content items in a digital magazine system;
retrieving a target action performed by a target user with a content item;
identifying view of the content item by viewing users of the digital magazine system, the target action contributing to the viewing users' view of the content item;
determining a contribution value of the target action for each viewing user's view of the content item, wherein determining the contribution value comprises:
determining a value of the viewing user's view of the content item,
identifying a group of contributing actions that contributed to the viewing user's view of the content item, the contributing actions including the target action,
classifying the contributing actions into one or more categories,
determining a category weight for a category including the target action,
determining a contribution weight for the target action based on the category weight, and
determining a contribution value of the target action based on the value of the viewing user's view of the content item and the contribution weight;
obtaining an action value of the target action by aggregating the contribution values of the target action for the viewing users' view of content item; and
rewarding the target user based on the action value.

20. The system of claim 19, wherein the value of a viewing user's view of the content item comprises a monetary portion to be received by the digital magazine system and an organic portion indicating an increase in user interaction in the digital magazine system.
